(19) United States
(12) Patent Application Publication
(10) Pub. No.: US 2023/0245037 A1
(43) Pub. Date: Aug. 3, 2023

(54) AUTOMATICALLY PREDICTING ARRIVAL TIMES FOR STOPS IN A DELIVERY ROUTE

(71) Applicant: Walmart Apollo, LLC, Bentonville, AR (US)

(72) Inventors: Bangxin Zhao, Hayward, CA (US); Chenxin Ma, Belmont, CA (US); Mingang Fu, Palo Alto, CA (US)

(73) Assignee: Walmart Apollo, LLC, Bentonville, AR (US)

(21) Appl. No.: 17/589,816

(22) Filed: Jan. 31, 2022

(51) Int. Cl. G06Q 10/08; G06K 9/62; G06N 20/00

(52) U.S. Cl. CPC G06Q 10/0833; G06Q 10/08355; G06Q 10/0838; G06K 9/6256; G06N 20/00

(57) ABSTRACT

A method to be implemented via execution of computing instructions configured to run at one or more processors and stored at one or more non-transitory computer-readable media. The method can include determining, via a source-departure-prediction machine learning model, a source departure time for a delivery route to one or more stops based at least in part on a load ready time. The source-departure-prediction machine learning model can include a first model and a second model. Determining the source departure time further can include using the first model to determine the source departure time, while not using the second model, when a commodity type of the delivery route is of a first type; and using the second model to determine the source departure time, while not using the first model, when the commodity type of the delivery route is not of the first type. The method additionally can include determining a respective transit time for each of one or more legs for the delivery route. The method also can include determining a respective intermediate stop dwell time for each of one or more intermediate stops of the one or more stops. The method further can include determining a respective estimated time of arrival for each of the one or more stops based on the source departure time, the respective transit time for each of the one or more legs, and the respective intermediate stop dwell time for each of the one or more intermediate stops. Other embodiments are also provided.

### TECHNICAL FIELD

This disclosure relates generally to automatically determining estimated times of arrival (ETAs).

### BACKGROUND

Existing arrival time estimating techniques generally cannot provide accurate ETAs for stops in a delivery route because these techniques generally predict ETAs based on an incorrect assumption that the delivery vehicles always leave a distribution center on time. Indeed, the time taken for processing and loading items to the delivery vehicles varies depending on various factors such as the commodity types of the items, the quantity of the items, etc. Therefore, systems and/or methods that can predict the time a delivery vehicle will leave the distribution center and in turn predict ETAs for stops in the delivery route more accurately are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically predicting arrival times for a multi-leg transportation, according to an embodiment; and

FIG. 4 illustrates a flow chart for a method for automatically determining a respective ETAs for each stop of a multi-leg transportation, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DESCRIPTION OF EXAMPLES OF EMBODIMENTS

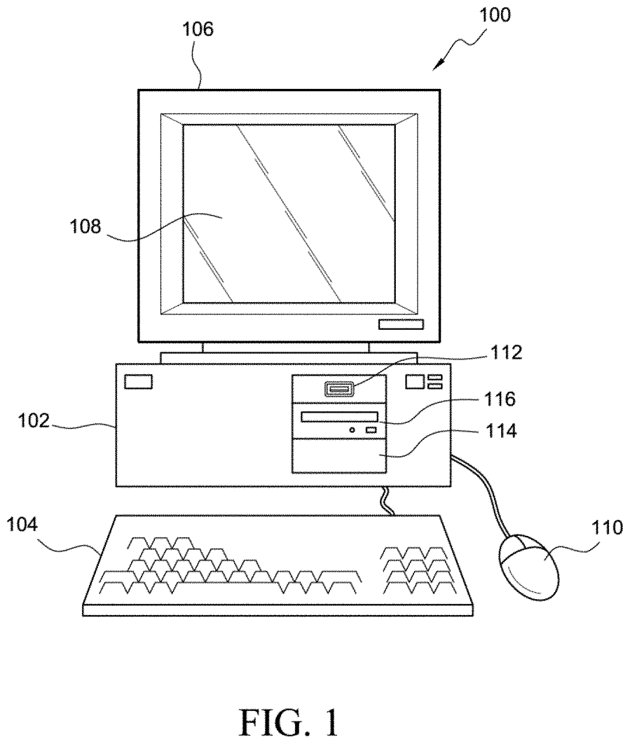

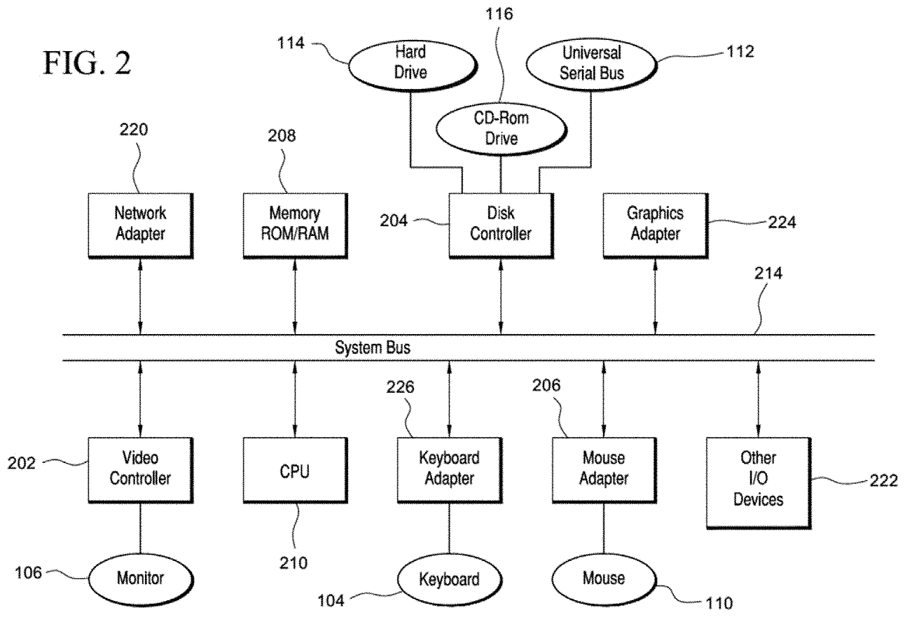

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. (Microsoft) of Redmond, Wash., United States of America, (ii) Mac® OS X by Apple Inc. (Apple) of Cupertino, Calif., United States of America, (iii) UNIX® OS, and (iv) Linux® OS. Further exemplary operating systems can comprise one of the following: (i) the iOS® operating system by Apple, (ii) the Blackberry® operating system by Research In Motion (RIM) of Waterloo, Ontario, Canada, (iii) the WebOS operating system by LG Electronics (LG) of Seoul, South Korea, (iv) the Android™ operating system developed by Google, Inc. (Google) of Mountain View, Calif., United States of America, or (v) the Windows Mobile™ operating system by Microsoft.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

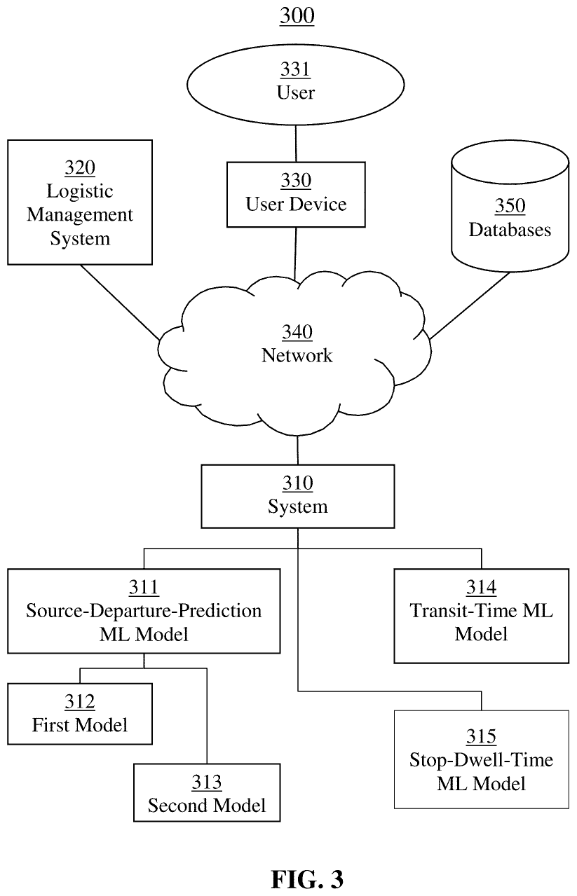

Turning ahead in the drawings, FIG. 3 illustrates a block diagram of a system 300 that can be employed for automatically predicting arrival times for one or more stops in a deliver itinerary, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., system 310 and/or logistic management system 320) and one or more user devices (e.g., user device 330) for various users (e.g., user 331). In a few embodiments, system 310 can include logistic management system 320. System 310, logistic management system 320, and/or user device 330 can each be a computer system, such as computer system 100 (FIG. 1), as described above, and can each be a single computer, a single server, or a cluster or collection of computers or servers, or a cloud of computers or servers. In another embodiment, a single computer system can host each of system 310, logistic management system 320, and/or user device 330. In many embodiments, system 310 can be modules of computing instructions (e.g., software modules) stored at non-transitory computer readable media that operate on one or more processors. In other embodiments, system 310 can be implemented in hardware. In many embodiments, system 310 can comprise one or more systems, subsystems, servers, modules, or models, such as one or more machine learning (ML) models (e.g., source-departure-prediction ML Model 311, first model 312, second model 313, transit-time ML model 314, and/or stop-dwell-time ML model 315), implemented via software and/or hardware. Additional details regarding system 310, source-departure-prediction ML Model 311, first model 312, second model 313, transit-time ML model 314, stop-dwell-time ML model 315, logistic management system 320, and/or user device 330 are further described below.

In some embodiments, system 310 can be in data communication, through network 340 (e.g., a computer network, a telephone network, or the Internet, etc.), with logistic management system 320 and/or user device 330. In some embodiments, user device 330 can be used by a user, such as user 331. In a number of embodiments, logistic management system 320 can be configured to determine one or more items to be transported by a vehicle from a distribution center (DC) to one or more stops (e.g., stores and/or regional warehouses) and plan a proposed delivery route from the DC to the one or more stops, in addition to other suitable activities. In certain embodiments, logistic management system 320 can transmit, via network 340, the proposed delivery route to system 310 for system 310 to determine estimated times of arrival (ETAs) for the one or more stops in the proposed delivery route.

In some embodiments, an internal network (e.g., network 340) that is not open to the public can be used for communications between system 310 with logistic management system 320 and/or user device 330. In these or other embodiments, the operator and/or administrator of system 310 can manage system 310, the processor(s) of system 310, and/or the memory storage unit(s) of system 310 using the input device(s) and/or display device(s) of system 310.

In certain embodiments, the user devices (e.g., user device 330) can be desktop computers, laptop computers, mobile devices, and/or other endpoint devices used by one or more users (e.g., user 331). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., databases 350). The one or more databases can include a delivery route database that includes information about delivery routes planned or executed. Examples of information about a delivery route in the delivery route database can include an estimated load ready time, an actual gate-out time, a commodity type of items transported or to be transported, the quantity of items transported or to be transported, the estimated quantity of pallets for loading the items, a stop sequence, a respective distance between each pair of adjacent stops, and so forth.

In some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units. Further, the one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or databases 350 can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can determine a source departure time for a delivery route to one or more stops based at least in part on a load ready time. The source departure time can be an estimated time that a delivery vehicle (e.g., a truck or reefer) will leave a distribution center and start the delivery route. The load ready time can be an estimated time, provided by a user (e.g., user 331) or logistic management system 320, that the items for the delivery route will be ready for packing and loading in the distribution center.

System 310 can use any suitable functions, rules, and/or machine learning models to determine the source departure time. In a number of embodiments, system 310 can use a pre-trained source-departure-prediction machine learning model (e.g., source-departure-prediction ML model 311) to determine the source departure time. The source-departure-prediction machine learning model further can include a first model (e.g., first model 312) and a second model (e.g., second model 313).

In some embodiments, determining the source departure time via the source-departure-prediction machine learning model (e.g., source-departure-prediction ML model 311) further can include: (a) using the first model (e.g., first model 312) to determine the source departure time, while not using the second model, when a commodity type of the delivery route is of a first type; and/or (b) using the second model (e.g., second model 313) to determine the source departure time, while not using the first model, when the commodity type of the delivery route is not of the first type. Examples of the commodity type can include dry goods that do not need to be refrigerated (e.g., clothing, nonperishable foods, paper products, kitchen appliances, gardening tools, furniture, etc.), temperature-sensitive commodities (e.g., perishable foods, pharmaceuticals, etc.), and so forth. In certain embodiments, the first type can be dry goods, and the non-first type can be temperature-sensitive commodities, or vice versa. The source-departure-prediction machine learning model, the first model, and/or the second model each can include any suitable machine learning algorithms, such as XGBoost, LightGBM, gradient boosting, etc. The machine learning algorithm(s) used by the first model and the second model can be similar or different.

In a few embodiments where the source-departure-prediction machine learning model (e.g., source-departure-prediction ML model 311) is used, system 310 additionally can adjust the source departure time determined by the source-departure-prediction machine learning model. For example, when: (a) the original load ready time is after a certain point of time (e.g., 8 am, 9 am, or 9:30 am, etc.), or (b) it is known that the items will not be ready at the original load ready time, and that the new load ready time will be delayed after the certain point of time, system 310 can add a predetermined additional time (e.g., 1 hour, 2 hours, 3 hours, etc.) or the time difference between the original load ready time and the new load ready time, to the source departure time.

Still referring to FIG. 3, in a number of embodiments, system 310 further can determine a respective transit time for each of one or more legs for the delivery route. The respective transit time for each of one or more legs for the delivery route can be an estimated time that the delivery vehicle will spend on each of the one or more legs. System 310 can determine the respective transit time for each of the one or more legs by any suitable functions, rules, and/or machine learning algorithms. In some embodiments, system 310 can use a pre-trained transit-time machine learning model (e.g., transit-time ML model 314) to determine the respective transit time. The transit-time machine learning can include any suitable machine learning models, such as random forest, XGBoost, or a weighted ensemble of random forest, XGBoost, etc.

In some embodiments, system 310 additionally can determine a respective intermediate stop dwell time for each of one or more intermediate stops of the one or more stops. The respective intermediate stop dwell time for each of the one or more intermediate stops can be an estimated time that the delivery vehicle will stay at each of the one or more intermediate stops, including the time taken for unloading items to each stop, a lunch break for the driver, etc. System 310 can determine the respective intermediate stop dwell time for each of the one or more intermediate stops by any suitable functions, rules, and/or machine learning algorithms. In several embodiments, system 310 can use a pre-trained stop-dwell-time machine learning model (e.g., stop-dwell-time ML model 315) to determine the respective transit time. The stop-dwell-time machine learning can include any suitable machine learning models, such as XGBoost, LightGBM, gradient boosting, etc.

In many embodiments, system 310 further can determine a respective estimated time of arrival (ETA) for each of the one or more stops based on the source departure time, the respective transit time for each of the one or more legs, and the respective intermediate stop dwell time for each of the one or more intermediate stops. In some embodiments, the respective estimated time of arrival for each stop of the one or more stops can include a respective time window (e.g., a 30-minute time window, a 1-hour time window, etc.).

In a number of embodiments, after determining the respective estimated time of arrival for each stop of the one or more stops, when at least one of one or more constraints is not satisfied (e.g., the ETA for a stop of the one or more stops is outside a receiving time window for the stop), system 310 further can take one or more acts to resolve the issues. For example, system 310 can re-determine or have logistic management system 320 re-plan the stop sequence for the delivery route and/or the one or more stops for the delivery route (e.g., removing the last stop from the one or more stops, etc.). Additionally or alternatively, if time allows, system 310 can propose a new load ready time based on the respective ETA determined above and the issues (e.g., moving the load ready time 2 hours earlier so that the ETA at the last stop can fit into the delivery window) and re-determine the respective ETA for each stop based on the proposed new load ready time. System 310 further can transmit, via network 340, the proposed new load ready time to a user (e.g., user 331) and/or logistic management system 320 to arrange the implementation of the new load ready time.

Conventional systems are unable to automatically determine accurate times of arrival for the stops (e.g., stores or regional warehouses) at the planning stage because they fail to take into consideration the time a distribution center takes to prepare and load items on the delivery vehicle, which can vary depending on the distribution center and the commodity type of the items to be loaded for the delivery route. Moreover, conventional systems rely on fixed one-size-fits-all functions and/or rules that lack the ability to automatically and dynamically improve the ETA prediction techniques used. Without accurate timing information, the management at the stops (e.g., stores or regional warehouses) cannot properly plan or manage employees' work schedules, which can result in slowdown in unloading and delay at the following legs/stops. In many embodiments, driver assignment techniques provided by system 300 and/or system 310 can advantageously address the problem by training one or more machine learning algorithms based on historical and dynamic input data and determining ETAs more accurately.

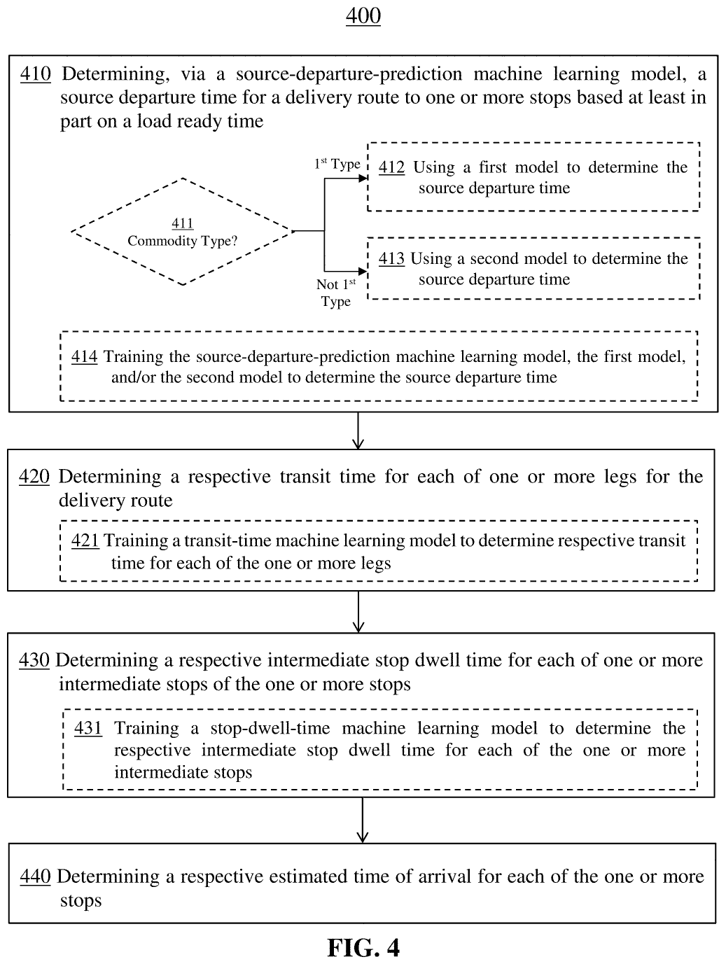

Turning ahead in the drawings, FIG. 4 illustrates a flow chart for a method 400, according to an embodiment. In many embodiments, method 400 can be implemented via execution of computing instructions on one or more processors for automatically determining an offer price for an order delivery. Method 400 is merely exemplary and is not limited to the embodiments presented herein. Method 400 can be employed in many different embodiments or examples not specifically depicted or described herein. In some embodiments, the procedures, the processes, the activities, and/or the blocks of method 400 can be performed in the order presented. In other embodiments, the procedures, the processes, the activities, and/or the blocks of method 400 can be performed in any suitable order. In still other embodiments, one or more of the procedures, the processes, the activities, and/or the blocks of method 400 can be combined or skipped.

In many embodiments, system 300 (FIG. 3) and/or system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

In many embodiments, method 400 can be performed by a computer server, such as system 300 (FIG. 3) and/or system 310 (FIG. 3), to determine a source departure time for a delivery route to one or more stops based at least in part on a load ready time. The source departure time can be an estimated point of time when a delivery vehicle for the delivery route is loaded and leaves the distribution center. In some embodiments, method 400 can be configured to voluntarily, or be requested by a user (e.g., user 331 (FIG. 3)) or a logistic management system (e.g., logistic management system 320 (FIG. 3)) to, start the activities described herein repeatedly at a predetermined frequency (e.g., daily, weekly, etc.) or when the load ready time is determined. Further, method 400 can use any suitable functions, rules, and/or machine learning algorithms to determine the source departure time.

In a number of embodiments, method 400 can determine the source departure time for the delivery route to the one or more stops based at least in part on the load ready time, via a pre-trained source-departure-prediction machine learning model (e.g., source-departure-prediction ML model 311 (FIG. 3)) (block 410). In some embodiments, the source-departure-prediction machine learning model system (e.g., source-departure-prediction ML model 311 (FIG. 3)) can comprise a first model (e.g., first model 312 (FIG. 3)) and a second model (e.g., second model 313 (FIG. 3)). Determining the source departure time via the source-departure-prediction machine learning model system in block 410 further can include: (a) determining whether or not a commodity type of the delivery route is of a first type (e.g., dry goods, meat products, frozen foods, dairy products, etc.) (block 411); (b) when a commodity type of the delivery route is of the first type, using the first model to determine the source departure time, while not using the second model (block 412); and/or (c) when the commodity type of the delivery route is not of the first type, using the second model to determine the source departure time, while not using the first model (block 413).

In many embodiments, method 400 further can include, before determining the source departure time, training the source-departure-prediction machine learning model (e.g., source-departure-prediction ML model 311 (FIG. 3)), the first model (e.g., first model 312 (FIG. 3)), and/or the second model (e.g., second model 313 (FIG. 3)) (block 414), based on a respective training dataset. In many embodiments, training the source-departure-prediction machine learning model includes training the first model and the second model in any suitable manner (e.g., concurrently or independently). In a number of embodiments, the source-departure-prediction machine learning model (e.g., source-departure-prediction ML model 311 (FIG. 3)), the first model (e.g., first model 312 (FIG. 3)), and/or the second model (e.g., second model 313 (FIG. 3)) each can include any suitable machine learning algorithms, such as XGBoost, LightGBM, decision trees, etc. The first model and the second model can include similar or different machine learning algorithms and be trained based on similar or different training datasets. In similar or different embodiments, the source-departure-prediction machine learning model can include one or more other ML models, in addition to the first model and the second model.

In some embodiments, the first model (e.g., first model 312 (FIG. 3)) can be trained based on a first training dataset. The first training dataset can include first historical input data and first historical output data associated with first prior delivery routes, each with the respective commodity type of the first type, from the distribution center. The first historical input data of the first training dataset can include feature vectors for the first prior delivery routes, and the first historical output data of the training dataset can include a respective prior source departure time for each of the first prior delivery routes. In some embodiments, the feature vectors of the first historical input data of the first training dataset can be associated with certain information of the first prior delivery routes. For instance, the information can include a respective first historical load ready time, a respective first historical commodity type, a respective first historical stop sequence, respective first historical loading information (e.g., a respective loading method, a load type, etc.), respective first historical delivery route information (e.g., day, time, and/or an overall distance of a prior first delivery route), a first historical time deviation value (e.g., a time difference between the respective first historical load ready time and a median of historical gate-out times), and/or respective first historical routing information (e.g., historical traffic data). In this way, the first model, as trained in block 414, can be configured to determine the source departure time for the delivery route based at least in part on the information of the delivery route from the distribution center, such as the load ready time, the commodity type that is of the first type, a stop sequence, loading information, delivery route information, a time deviation value, and/or routing information for this delivery route.

In several embodiments, the second model (e.g., second model 313 (FIG. 3)) can be trained based on a second training dataset. The second training dataset can include second historical input data and second historical output data associated with second prior delivery routes, each with a respective commodity type not of the first type, from the distribution center. The second historical input data of the second training dataset can include feature vectors for the second prior delivery routes, and the second historical output data of the second training dataset can include a respective prior source departure time for each of the second prior delivery routes. In some embodiments, the feature vectors of the second historical input data of the second training dataset can be associated with certain information of the second prior delivery routes. For instance, the information can include a respective second historical load ready time, a respective second historical commodity type, a respective second historical stop sequence, respective second historical loading information, respective second historical delivery route information (e.g., day, time, and/or an overall distance of a prior second delivery route), and a second historical time deviation value (e.g., a time difference between the respective second historical load ready time and a median of historical gate-out times for the second prior delivery routes). In this way, the second model, as trained in block 414, can be configured to determine the source departure time for the delivery route based at least in part on the information of the delivery route from the distribution center, such as the load ready time, the commodity type that is not of the first type, the stop sequence, the loading information, the delivery route information, the time deviation value, and/or the routing information for this delivery route.

In some embodiments, the first prior delivery routes and the second prior delivery routes can be prior delivery routes planned and/or taken during the same, overlapping, or different time periods. In certain embodiments, a first input size of each of the first historical input feature vectors can be the same or different from a second input size of each of the second historical input feature vectors.

In several embodiments, method 400 further can include updating the source departure time based on a real-time departure delay status for the delivery route in block 410. In certain embodiments, after the source departure time is determined as above, block 410 can adjust the source departure time based on the expected delay or a fixed number when some incidents happen or will happen and cause the load ready time to become later than a predetermined point of time (e.g., after 7 am, 9 am, or 12 pm) or to fall into a predetermined time window (e.g., 8:30-9:30 am or the rush hour of the day for the delivery route). For instance, when the load ready time is expected to be delayed and will be later than a predetermined point of time (e.g., 8 am or 9 am), block 410 can adjust the source departure time by adding the fixed number (e.g., 1 hour, 2.5 hours, 3 hours, etc.) to the source departure time determined by the source-departure-prediction machine learning model (e.g., source-departure-prediction ML model 311 (FIG. 3)).

In a number of embodiments, method 400 additionally can include determining a respective transit time for each of one or more legs for the delivery route (block 420). The respective transit time for a leg of the one or more legs can be an estimated duration that the delivery vehicle will on the road from a stop to another. In some embodiments, the respective transit time can be determined based at least in part on the load ready time, the commodity type, the stop sequence, the delivery leg information (e.g., a respective distance of each leg, the total distance for the entire delivery route, etc.), an order quantity (e.g., the quantity of items to be transported), and the delivery timing information (e.g., the day of week) for the delivery route. The respective transit time for each of the one or more legs for the delivery route further can be determined based on any suitable functions, rules, and/or machine learning algorithms. In a number of embodiments, method 400 further can use a pre-trained transit-time machine learning model (e.g., transit-time ML model 314 (FIG. 3)) to determine the respective transit time for each of the one or more legs.

In several embodiments, method 400 also can include, prior to determining the respective transit time for each of the one or more legs, training the transit-time machine learning model (e.g., transit-time ML model 314 (FIG. 3)) in block 421, based on a third training dataset. The transit-time machine learning model used in block 420 and/or trained in block 421 can include any suitable machine learning algorithms or weighted ensembles of various machine learning algorithms, such as random forest, XGBoost, a weighted ensemble of random forest and XGBoost, etc.

In many embodiments, the third training dataset for the transit-time machine learning model (e.g., transit-time ML model 314 (FIG. 3)) can include third historical input data and third historical output associated with third prior delivery routes. In some embodiments, the third prior delivery routes for the third training dataset can include some or all of the first prior delivery routes and/or some or all of the second prior delivery routes.

In a number of embodiments, the third historical input data of the third training dataset for the transit-time machine learning model (e.g., transit-time ML model 314 (FIG. 3)) can include feature vectors for the third prior delivery routes, such as a respective third historical load ready time, a respective third historical commodity type, a respective third historical stop sequence, respective third historical delivery leg information (e.g., a respective distance of each leg of a prior delivery route of the third prior delivery routes and/or the total distance of the prior delivery route, etc.), a respective third historical order quantity, and respective third historical delivery timing information (e.g., a respective date of week, a respective start time of each leg, etc.) for each of the third prior delivery routes. The historical output data of the training dataset can include a respective transit time for each of the third prior delivery routes. As such, the transit-time learning model, as trained in block 421, can be configured to determine the respective transit time for each leg of the one or more legs for the delivery route can be determined based at least in part on the load ready time, the commodity type, the stop sequence, the delivery leg information, the order quantity, and the delivery timing information for the delivery route.

In a number of embodiments, method 400 further can include determining a respective intermediate stop dwell time for each of one or more intermediate stops of the one or more stops for the delivery route (block 430). The respective intermediate stop dwell time for an intermediate stop of the one or more intermediate stops can include an estimated duration in which the delivery vehicle will stay at the intermediate stop for unloading and/or for the driver to take a break. In many embodiments, the respective intermediate stop dwell time for each of the one or more intermediate stops can be determined based on any suitable functions, rules, and/or machine learning algorithms. In some embodiments, method 400 can use a pre-trained stop-dwell-time machine learning model (e.g., stop-dwell-time ML model 315 (FIG. 3)) to determine the respective intermediate stop dwell time for each of one or more intermediate stops of the one or more stops (block 431). In many embodiments, method 400 can include training the stop-dwell-time machine learning model in block 431 with a fourth training dataset. The stop-dwell-time machine learning model used in block 430 and/or trained in block 431 can include any suitable machine learning algorithms, such as XGBoost, decision trees, etc.

In many embodiments, the fourth training dataset for training the stop-dwell-time machine learning model (e.g., stop-dwell-time ML model 315 (FIG. 3)) in block 431 can be associated with fourth prior delivery routes. In some embodiments, the fourth prior delivery routes used in the fourth training dataset for training the stop-dwell-time machine learning model in block 431 can include some or all of the first prior delivery routes, the second prior delivery routes, and/or the third prior delivery routes.

In some embodiments, the fourth training dataset additionally can include historical input data and historical output data associated with the fourth prior delivery routes. The historical input data of the fourth training dataset can include feature vectors for the fourth prior delivery routes, and the historical output data of the fourth training dataset can include a respective prior intermediate stop dwell time for each of one or more intermediate stops of one or more stops for each of the fourth prior delivery routes. In some embodiments, the feature vectors of the historical input data of the fourth training dataset can be associated with certain information of the fourth prior delivery routes. For instance, the information can include a respective fourth historical stop sequence, respective fourth historical carrier information (e.g., a truck, a van, a reefer, etc.; and/or the weight or capacity of the delivery vehicle, etc.), respective fourth historical load information (e.g., the quantity of items and/or pallets loaded, the weight of the load, etc.), respective fourth historical driver shift information (e.g., breaks taken by the drivers), and respective fourth historical stop timing information (e.g., a day of week and/or an hour of day for a respective arrival time at an intermediate stop of the one or more intermediate stops, an average dwell stop for the one or more intermediate stops for a prior delivery route or each of the fourth prior delivery routes, etc.) for each of the one or more intermediate stops of the one or more stops for each of the fourth prior delivery routes. In this way, the stop-dwell-time machine learning model, as trained in block 431, can be configured to determine the respective intermediate stop dwell time for each of one or more intermediate stops of the one or more stops for the delivery route based on a stop sequence, carrier information (e.g., the type, capacity, and/or weight of a delivery vehicle), load information (e.g., the quantity of items/pallets to be loaded), driver shift information (e.g., potential breaks for the driver), and stop timing information (e.g., the day of week for the delivery route) for each of the one or more intermediate stops of the one or more stops for the delivery route.

In various embodiments, block 410, block 420, and block 430 can be executed in sequence, as shown in FIG. 4 or in different orders, independently, or concurrently. In some embodiments, before performing block 410, block 420, or block 430, method 400 can include determining the delivery route, including the one or more stops, the stop sequence, the commodity type, the items to be loaded, the date of the delivery route, etc.

In many embodiments, method 400 further can include a block 440 for determining respective estimated time of arrival for each of the one or more stops for the delivery route based on: (a) the source departure time determined in block 410, (b) the respective transit time for each of the one or more legs for the delivery route determined in block 420, and (c) the respective intermediate stop dwell time for each of the one or more intermediate stops determined in block 430. For example, the ETA of the i^{th} stop (ETAᵢ) of a delivery route with multiple stops can be: ETAᵢ=T_{source_departure}+Σⱼ₌₀ⁱ⁻¹tₜᵣₐₙₛᵢₜ(j, j+1)+Σⱼ₌₁ⁱ⁻¹t_{stop_dwell}(j), wherein T_{source_departure} is the source departure time; tₜᵣₐₙₛᵢₜ(j, j+1) is the respective transit time between the j^{th} stop (the 0^{th} stop being the DC) and the (j+1)^{th} stop before the i^{th} stop in the delivery route; and t_{stop_dwell}(j, j+1) is the respective store-dwell time of the j^{th} stop before the i^{th} stop in the delivery route.

In some embodiments, the respective estimated time of arrival for each stop of the one or more stops for the delivery route in block 440 can include a respective time window (e.g., a 1-hour time window, a 2-hour time window, a 4-hour time window, etc.). In a number of embodiments, block 440 further can include, after determining the respective estimated time of arrival for each of the one or more stops, when at least one of one or more constraints is not satisfied, re-determining one or more of: a stop sequence for the delivery route; the one or more stops for the delivery route; or the load ready time. Examples of the one or more constraints can include that the respective estimated time of arrival for each of the one or more stops needs to fall in a respective receiving time window for the stop. Re-determining the one or more stops for the delivery route can include removing at least one stop from the one or more stops. Further, because method 400 can be executed in the planning stage, block 440 can propose a new load ready time based on the respective ETA of each stop of the one or more stops and the at least one constraint at issue (e.g., moving the load ready time 2 hours earlier so that the ETA at the last stop can fit into the delivery window) and re-start the activities in blocks 410, 420, 430, and 440 based on the proposed new load ready time until all of the one or more constraints are satisfied. In a number of embodiments, the estimated times of arrival can be provided to the stops (e.g., the DC, stores, or regional warehouses) along the delivery route for the stops to plan and arrange their employees' working schedule accordingly and/or transmitted to a mobile device of a driver of a delivery vehicle to be displayed to driver.

In various embodiments, any machine learning model provided above for method 400 (e.g., the source-departure-prediction machine learning model in block 410 or 414, the first model in block 412 or 414, the second model in block 413 or 414, the transit-time machine learning model in block 421, and/or the stop-dwell-time machine learning model in block 431) can be pre-trained, or re-trained, based on a corresponding training dataset. In some embodiments, a machine learning model used in method 400 can also consider both historical and dynamic input from the system performing method 400 (e.g., system 300 (FIG. 3) or 310 (FIG. 3)). In this way, the machine learning model can be trained iteratively as data from the system is added to the corresponding training dataset. In many embodiments, the machine learning model can be iteratively trained in real time as data is added to the corresponding training dataset.

In some embodiments, the machine learning model for method 400 (e.g., the source-departure-prediction machine learning model in block 410 or 414, the first model in block 412 or 414, the second model in block 413 or 414, the transit-time machine learning model in block 421, and/or the stop-dwell-time machine learning model in block 431) can be trained, at least in part, on a single DC's delivery routes or the single DC's delivery routes can be weighted in a training dataset. In this way, the machine learning model can be tailored to a single DC. In similar or different embodiments, the machine learning model for method 400 (e.g., the source-departure-prediction machine learning model in block 410 or 414, the first model in block 412 or 414, the second model in block 413 or 414, the transit-time machine learning model in block 421, and/or the stop-dwell-time machine learning model in block 431) can be trained, at least in part, on delivery routes of a group of multiple DCs (e.g., DCs in the same area or state). In several embodiments, due to a large amount of data used to create and maintain the training dataset, the machine learning model can use extensive data inputs to determine base delivery prices, desirability scores of the base delivery prices, and/or the elasticity of the desirability scores, etc. Due to these extensive data inputs, in many embodiments, creating, training, and/or using a machine learning model configured to determine base prices, desirability of the base prices, and/or the elasticity of the desirability scores cannot practically be performed in a mind of a human being.

Various embodiments can include a system for determining a delivery offer price to be used in a driver assignment process for a delivery request. The system can include one or more processors and one or more non-transitory computer-readable media storing computing instructions that, when executed on the one or more processors, cause the one or more processors to perform various acts.

In a number of embodiments, the acts can include determining, via a source-departure-prediction machine learning model, a source departure time for a delivery route to one or more stops based at least in part on a load ready time. In certain embodiments, the source-departure-prediction machine learning model can include a first model and a second model, and determining the source departure time further can include: (a) using the first model to determine the source departure time, while not using the second model, when a commodity type of the delivery route is of a first type; and (b) using the second model to determine the source departure time, while not using the first model, when the commodity type of the delivery route is not of the first type.

In some embodiments, the acts further can include determining a respective transit time for each of one or more legs for the delivery route. Moreover, the acts can include determining a respective intermediate stop dwell time for each of one or more intermediate stops of the one or more stops. The acts additionally can include determining a respective estimated time of arrival for each of the one or more stops based on the source departure time, the respective transit time for each of the one or more legs, and the respective intermediate stop dwell time for each of the one or more intermediate stops.

Further, various embodiments can include a method being implemented via execution of computing instructions configured to run at one or more processors and stored at one or more non-transitory computer-readable media. The method can comprise determining, via a source-departure-prediction machine learning model, a source departure time for a delivery route to one or more stops based at least in part on a load ready time. The source-departure-prediction machine learning model can include a first model and a second model, and determining the source departure time further can include: (a) using the first model to determine the source departure time, while not using the second model, when a commodity type of the delivery route is of a first type; and (b) using the second model to determine the source departure time, while not using the first model, when the commodity type of the delivery route is not of the first type.

The method further can include determining a respective transit time for each of one or more legs for the delivery route. The method additionally can determining a respective intermediate stop dwell time for each of one or more intermediate stops of the one or more stops. Finally, the method also can include determining a respective estimated time of arrival for each of the one or more stops based on the source departure time, the respective transit time for each of the one or more legs, and the respective intermediate stop dwell time for each of the one or more intermediate stops.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatically predicting respective ETAs for one or more stops in a delivery route has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments. Different functions and/or machine learning algorithms may be used to determine the source departure time, the respective transit time, and/or the respective intermediate stop dwell time. Various training datasets can be used for training the one or more machine learning models described above.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
determining, via a source-departure-prediction machine learning model, a source departure time for a delivery route to one or more stops based at least in part on a load ready time, wherein:
the source-departure-prediction machine learning model comprises a first model and a second model; and
determining the source departure time further comprises:
using the first model to determine the source departure time, while not using the second model, when a commodity type of the delivery route is of a first type; and
using the second model to determine the source departure time, while not using the first model, when the commodity type of the delivery route is not of the first type;
determining a respective transit time for each of one or more legs for the delivery route;
determining a respective intermediate stop dwell time for each of one or more intermediate stops of the one or more stops; and
determining a respective estimated time of arrival for each of the one or more stops based on the source departure time, the respective transit time for each of the one or more legs, and the respective intermediate stop dwell time for each of the one or more intermediate stops.

2. The system in claim 1, wherein:
determining the source departure time further comprises updating the source departure time based on a real-time departure delay status for the delivery route.

3. The system in claim 1, wherein:
the first model is pre-trained based on first historical input feature vectors and first historical departure times;
the second model is pre-trained based on second historical input feature vectors and second historical departure times;
a first input size of each of the first historical input feature vectors is different from a second input size of each of the second historical input feature vectors; and
at least one of:
each of the first historical input feature vectors is associated with respective first historical input data comprising a respective first historical load ready time, a respective first historical commodity type, a respective first historical stop sequence, respective first historical loading information, respective first historical delivery route information, a first historical time deviation value, and respective first historical routing information; or
each of the second historical input feature vectors is associated with respective second historical input data comprising a respective second historical load ready time, a respective second historical commodity type, a respective second historical stop sequence, respective second historical loading information, respective second historical delivery route information, and a second historical time deviation value.

4. The system in claim 1, wherein:
determining the respective transit time for each of the one or more legs for the delivery route further comprises determining, by a transit-time machine learning model, the respective transit time for each of the one or more legs for the delivery route.

5. The system in claim 4, wherein:
the transit-time machine learning model is pre-trained based on third historical input feature vectors and historical output transit times; and
each of the third historical input feature vectors is associated with respective third historical input data comprising a respective third historical load ready time, a respective third historical commodity type, a respective third historical stop sequence, respective third historical delivery leg information, a respective third historical order quantity, and respective third historical delivery timing information.

6. The system in claim 4, wherein:
the transit-time machine learning model comprises a weighted ensemble of multiple machine learning algorithms.

7. The system in claim 1, wherein:
determining the respective intermediate stop dwell time for each of the one or more intermediate stops further comprises determining, by a stop-dwell-time machine learning model, the respective intermediate stop dwell time for each of the one or more intermediate stops.

8. The system in claim 7, wherein:
the stop-dwell-time machine learning model is pre-trained based on fourth historical input feature vectors and historical output stop dwell times; and
each of the fourth historical input feature vectors is associated with respective fourth historical input data comprising a respective fourth historical stop sequence, respective fourth historical carrier information, respective fourth historical load information, respective fourth historical driver shift information, and respective fourth historical stop timing information.

9. The system in claim 1, wherein:
the respective estimated time of arrival for each of the one or more stops comprises a respective time window.

10. The system in claim 1, wherein the computing instructions, when executed on the one or more processors, further cause the one or more processors to perform:
after determining the respective estimated time of arrival for each of the one or more stops, when at least one of one or more constraints is not satisfied, re-determining one or more of:
a stop sequence for the delivery route;
the one or more stops for the delivery route; or
the load ready time.

11. A method being implemented via execution of computing instructions configured to run at one or more processors and stored at one or more non-transitory computer-readable media, the method comprising:
determining, via a source-departure-prediction machine learning model, a source departure time for a delivery route to one or more stops based at least in part on a load ready time, wherein:
the source-departure-prediction machine learning model comprises a first model and a second model; and
determining the source departure time further comprises:
using the first model to determine the source departure time, while not using the second model, when a commodity type of the delivery route is of a first type; and
using the second model to determine the source departure time, while not using the first model, when the commodity type of the delivery route is not of the first type;
determining a respective transit time for each of one or more legs for the delivery route;
determining a respective intermediate stop dwell time for each of one or more intermediate stops of the one or more stops; and
determining a respective estimated time of arrival for each of the one or more stops based on the source departure time, the respective transit time for each of the one or more legs, and the respective intermediate stop dwell time for each of the one or more intermediate stops.

12. The system in claim 1, wherein:
determining the source departure time further comprises updating the source departure time based on a real-time departure delay status for the delivery route.

13. The method in claim 11, wherein:
the first model is pre-trained based on first historical input feature vectors and first historical departure times;
the second model is pre-trained based on second historical input feature vectors and second historical departure times;
a first input size of each of the first historical input feature vectors is different from a second input size of each of the second historical input feature vectors; and
at least one of:
each of the first historical input feature vectors is associated with a respective first historical input data comprising a respective first historical load ready time, a respective first historical commodity type, a respective first historical stop sequence, respective first historical loading information, respective first historical delivery route information, a first historical time deviation value, and respective first historical routing information; or
each of the second historical input feature vectors is associated with a respective second historical input data comprising a respective second historical load ready time, a respective second historical commodity type, a respective second historical stop sequence, respective second historical loading information, respective second historical delivery route information, and a second historical time deviation value.

14. The method in claim 11, wherein:
determining the respective transit time for each of the one or more legs for the delivery route further comprises determining, by a transit-time machine learning model, the respective transit time for each of the one or more legs for the delivery route.

15. The method in claim 14, wherein:
the transit-time machine learning model is pre-trained based on third historical input feature vectors and historical output transit times; and
each of the third historical input feature vectors is associated with a respective third historical load ready time, a respective third historical commodity type, a respective third historical stop sequence, respective third historical delivery leg information, a respective third historical order quantity, and respective third historical delivery timing information.

16. The method in claim 14, wherein:
the transit-time machine learning model comprises a weighted ensemble of multiple machine learning algorithms.

17. The method in claim 11, wherein:
determining the respective intermediate stop dwell time for each stop of the one or more intermediate stops further comprises determining, by a stop-dwell-time machine learning model, the respective intermediate stop dwell time for each stop of the one or more intermediate stops.

18. The method in claim 17, wherein:
the stop-dwell-time machine learning model is pre-trained based on fourth historical input feature vectors and historical output transit times; and
each of the fourth historical input feature vectors is associated with respective fourth historical input data comprising a respective fourth historical stop sequence, respective fourth historical carrier information, respective fourth historical load information, respective fourth historical driver shift information, and respective third historical stop timing information.

19. The method in claim 11, wherein:
the respective estimated time of arrival for each stop of the one or more stops comprises a respective time window.

20. The method in claim 11 further comprising:
after determining the respective estimated time of arrival for each stop of the one or more stops, when at least one of one or more constraints is not satisfied, re-determining one or more of:
a stop sequence for the delivery route;
the one or more stops for the delivery route; or
the load ready time.
